(19) United States
(12) Patent Application Publication
(10) Pub. No.: US 2009/0027450 A1
(43) Pub. Date: Jan. 29, 2009

(54) INKJET PRINT HEAD AND MANUFACTURING METHOD THEREOF

(75) Inventors: Sung Joon PARK, Suwon-si (KR); Tae Jin Kim, Suwon-si (KR); Dai Geun Kim, Hwaseong-si (KR); Jeong Wuk Han, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/117,029

(22) Filed: May 8, 2008

(30) Foreign Application Priority Data
Jul. 23, 2007 (KR) 2007-70812

(51) Int. Cl. B41J 2/14

(52) U.S. Cl. 347/47; 29/890.1

(57) ABSTRACT

An inkjet print head and a manufacturing method thereof capable of simplifying a manufacturing process without performing an additional process to form a heater layer that includes a substrate, a heating element stacked on the substrate to heat the ink, a transistor having a gate electrode to drive the heating element, a chamber layer to form an ink chamber filled with the ink above the heating element, and a nozzle layer stacked on the chamber layer to form a nozzle to eject the ink, wherein the gate electrode and the heating element include a metal silicide film formed through a salicide process.

### CROSS-REFERENCE TO RELATED APPLICATIONS

This application claims priority under 35 U.S.C. §119(a) from Korean Patent Application No. 2007-0070812, filed on Jul. 13, 2007 in the Korean Intellectual Property Office, the disclosure of which is incorporated herein in its entirety by reference.

### BACKGROUND OF THE INVENTION

1. Field of the Invention

The present general inventive concept relates to an inkjet print head and a manufacturing method thereof, and, more particularly, to an inkjet print head and a manufacturing method thereof, wherein a semiconductor process is used in a manufacturing process of the inkjet print head to promote efficiency.

2. Description of the Related Art

An inkjet print head is a device to eject ink droplets to print onto a desired position on a printing medium to form an image.

The inkjet print head is largely classified into a thermal driving type inkjet print head and a piezoelectric driving type inkjet print head according to the ink droplet ejection mechanism. The thermal driving type inkjet print head generates bubbles in the ink using a heat source and ejects the ink droplets by an expansion force of the bubbles.

Generally, the thermal driving type inkjet print head includes a substrate which is configured as a silicon wafer, an ink supply hole which is formed on the substrate to supply ink, a channel forming layer to form a channel and plural ink chambers on the substrate, a nozzle layer which is formed on the channel forming layer and has plural nozzles corresponding to the ink chambers, and a heater layer which has plural heating portions and is provided corresponding to the ink chambers to heat the ink in the ink chambers.

The heater layer of the inkjet print head is formed of barrier metal, and the heater layer is formed of a heat resistant material such as tantalum nitride (TaN) and tantalum-aluminum (Ta—Al).

In case of using the barrier metal, however, there is a problem such that a separate process should be performed to form a heater. In case of using a metal material, there are problems such that durability is reduced and a resistance value increases at portions of contact and via when the metal material is applied to a process of a semiconductor with a fine width.

In order to solve the problems, Korean Patent Laid-open Publication No. 2003-0018799, which is filed by an applicant of the present general inventive concept and published, relates to a method of forming an inkjet print head only by processing a single semiconductor substrate.

The method of forming an inkjet print head disclosed in the above referenced publication includes forming a device isolation film on a semiconductor substrate, forming a gate insulating film, a gate pattern and a heating element pattern on the substrate with the device isolation film, performing ion injection using the gate pattern as a mask to form MOS transistors with source/drain regions, forming an interlayer insulating film on the entire surface of the substrate to cover the MOS transistors and patterning the interlayer insulating film to form contact holes which expose at least a portion of the source/drain regions, depositing a conductive film on the entire surface of the substrate with the contact holes and patterning the conductive film to form source/drain electrodes and lines, depositing a protective film on the source/drain electrodes and lines, forming an etching mask on the substrate with the protective film and performing an etching to form nozzle holes which expose the semiconductor substrate in a region adjacent to the heating element pattern, performing an isotropic etching on the substrate with the nozzle holes to form ink chambers on the substrate, and patterning a substrate surface opposite to a substrate surface with the protective film to form a manifold space which supplies ink to the ink chambers.

In the method of forming an inkjet print head disclosed in the above referenced publication, the heating element pattern may be formed of polysilicon and a silicide layer in the forming of the gate pattern and the heating element pattern. Additional photolithography process and etching process should be performed to form the silicide layer, thereby complicating the process.

Further, in the invention disclosed in the above referenced publication, the source/drain electrodes and lines are formed on a single interlayer insulating film. Accordingly, since a circuit line width of the electrodes and lines is relatively small, the resistance increases and the performance of the heating element is reduced.

### SUMMARY OF THE INVENTION

The present general inventive concept provides an inkjet print head and a manufacturing method thereof capable of simplifying a manufacturing process without performing an additional process to form a heater layer.

The present general inventive concept also provides an inkjet print head and a manufacturing method thereof capable of suppressing an increase in a resistance of lines.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing a inkjet print head including a substrate, a heating element stacked on the substrate to heat ink, a transistor having a gate electrode to drive the heating element, a chamber layer to form an ink chamber filled with the ink above the heating element, and a nozzle layer stacked on the chamber layer to form a nozzle to eject the ink, wherein the gate electrode and the heating element include a metal silicide film formed through a salicide process.

The metal silicide film can be a titanium silicide film or a cobalt silicide film.

First and second interlayer insulating films can be formed between the heating element and the chamber layer, and first and second metal lines are patterned on the first and second interlayer insulating films.

The foregoing and/or other aspects and utilities of the general inventive concept may also be achieved by providing an inkjet print head including a plurality of chambers filled with ink, a plurality of heating elements to heat the ink in the chambers, a transistor to apply current to the heating elements, and a plurality of nozzles corresponding to the chambers, wherein the heating elements include a heating pattern formed of polysilicon and a metal silicide film formed by performing heat treatment on a metal film serving as a thin film stacked on the heating pattern.

The foregoing and/or other aspects and utilities of the general inventive concept may also be achieved by providing a method of manufacturing an inkjet print head including forming a gate pattern and a heating element pattern on a substrate, forming a metal film on the substrate, performing a first heat treatment on the metal film such that the gate pattern and the heating element pattern react with each other to form a first metal silicide film, removing a non-reacted film remaining on the substrate, stacking an interlayer insulating film on the substrate to form a metal line, stacking a channel forming layer to provide an ink chamber at a portion corresponding to the heating element pattern and stacking a nozzle layer such that a nozzle is formed at a portion corresponding to the ink chamber.

The method may further include performing a second heat treatment after removing the non-reacted film to form a second metal silicide film.

The stacking an interlayer insulating film on the substrate to form a metal line may include stacking a first interlayer insulating film on the gate pattern and the heating element pattern with the metal silicide film to pattern a first metal line, and stacking a second interlayer insulating film on the first metal line to pattern a second metal line.

The metal film is formed of cobalt.

The metal film can be formed of titanium, and the first heat treatment can be performed at a temperature of to 650˜670° C.

The metal film can be formed of titanium, and the second heat treatment can be performed at a temperature of to 850˜870° C.

The second metal silicide film can be a TiSi2 film or a CoSi2 film.

The foregoing and/or other aspects and utilities of the general inventive concept may also be achieved by providing an inkjet print head including one or more heating elements to heat ink, one or more transistors having source/drain regions and a gate electrode to drive a respective heating element and a metal silicide film selectively formed on and to reduce a resistance of the respective gate electrode and the source/drain regions.

The metal silicide film may include one of a cobalt silicide film and a titanium silicide film.

The foregoing and/or other aspects and utilities of the general inventive concept may also be achieved by providing an inkjet print head including a plurality of interlayer insulating films, and a first set of metal lines and a second metal line formed on the plurality of interlayer insulating films, respectively, wherein the metal lines are arranged in plural layers to form a width.

The second metal line may include a power line to connect to the first set of metal lines.

The foregoing and/or other aspects and utilities of the general inventive concept may also be achieved by providing a method of forming an inkjet print head, the method including forming a gate electrode and source/drain regions, and selectively forming a metal silicide film on the gate electrode and the source/drain regions to reduce a resistance thereof.

The method may further include simultaneously forming a heating element and the gate electrode.

The foregoing and/or other aspects and utilities of the general inventive concept may also be achieved by providing a method of forming an inkjet print head, the method including forming a plurality of interlayer insulating films, and forming a first set of metal lines and a second metal line formed on the plurality of interlayer insulating films, respectively, such that the metal lines are arranged in plural layers to form a width.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, of which:

FIG. 1 illustrates a process flowchart illustrating a method of manufacturing an inkjet print head according to an embodiment of the present general inventive concept; and

FIGS. 2A to 4D illustrate cross-sectional views illustrating an inkjet print head and a manufacturing method thereof according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to like elements throughout. The embodiments are described below in order to explain the present general inventive concept by referring to the figures.

Hereinafter, embodiments according to the present general inventive concept will be described in detail with reference to the accompanying drawings.

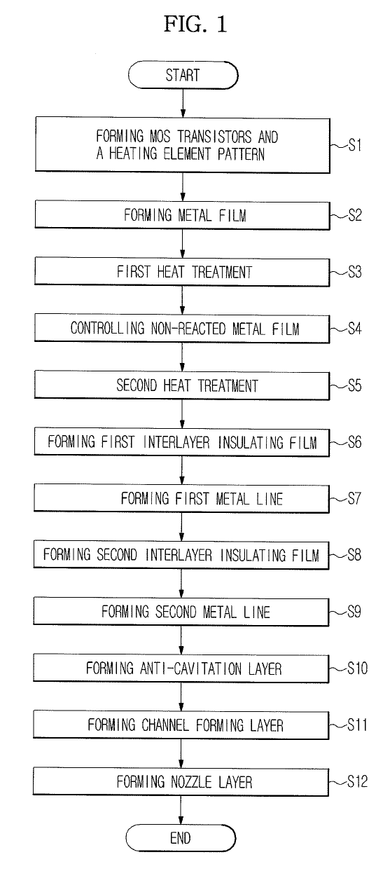

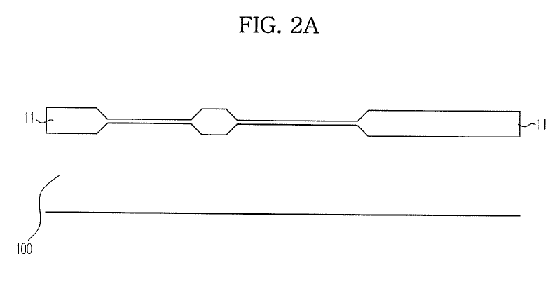

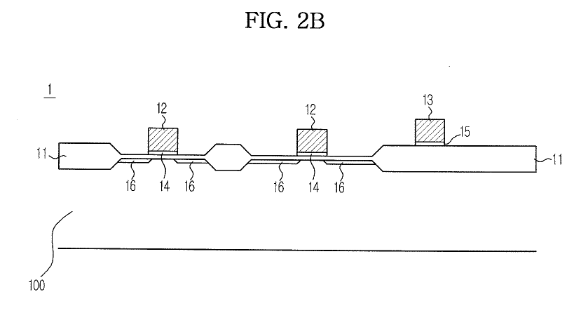

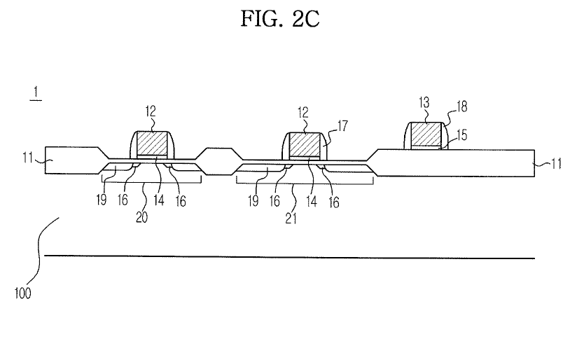

FIG. 1 illustrates a process flowchart explaining a method of manufacturing an inkjet print head according to an embodiment of the present general inventive concept. FIGS. 2A to 4D illustrate cross-sectional views illustrating an inkjet print head and a manufacturing method thereof according to an embodiment of the present general inventive concept.

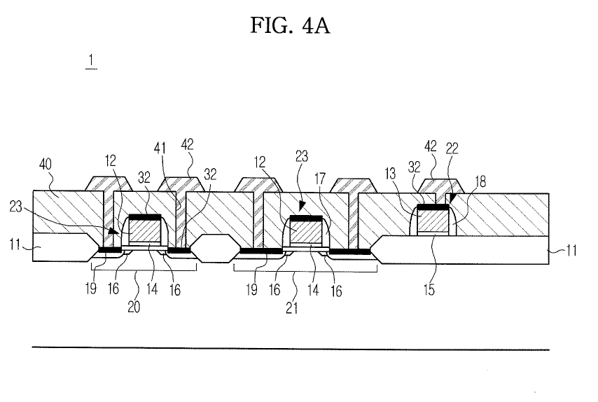

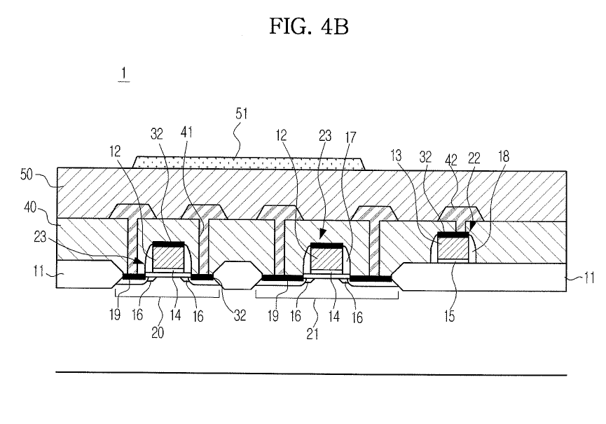

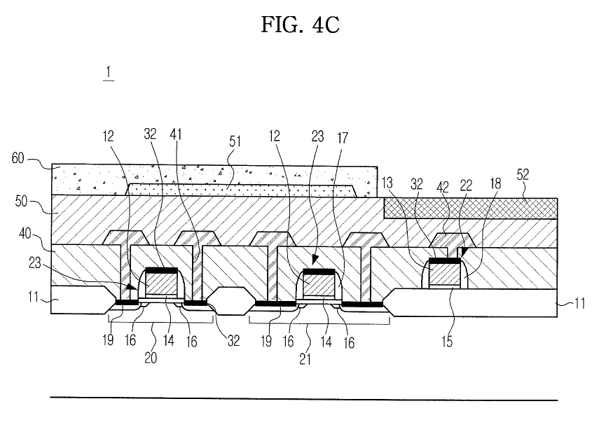

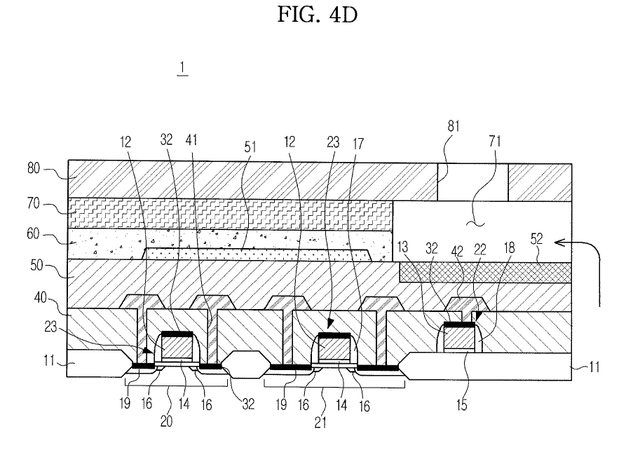

Referring to FIGS. 1 and 4D, MOS transistors 20 and 21 and a heating element pattern 13 are formed on a substrate 100 (operation S1).

The MOS transistors 20 and 21 include a transistor 20 serving as a switch for each nozzle 81 in a matrix region formed as the nozzle 81 to eject ink in a print head 1 and the transistor 21 forming a peripheral circuit portion. In this case, a CMOS structure of transistors is formed in the peripheral circuit portion. The CMOS structure may be formed through a general process which is widely known in a semiconductor field.

FIGS. 2A to 2C illustrate formation of transistors 20 and 21. For example, referring to FIG. 2A, a device isolation film 11 is formed in a specified region of a semiconductor substrate 100 by a local oxidation of silicon (LOCOS) process to define an active region.

As illustrated in FIG. 2B, a gate insulating film is formed in the active region of the substrate 100 to form a gate pattern 12 and the heating element pattern 13.

A gate conductive film is formed to form the gate pattern 12 and the gate conductive film may be formed of a silicon film such as a polysilicon film.

The silicon film may be doped with n-type impurities or p-type impurities. The gate conductive film may be formed by sequentially stacking a silicon film and a tungsten silicide film.

Next, the gate conductive film is patterned to form the gate pattern 12 crossing on the active region and form the heating element pattern 13 on the device isolation film 11 corresponding to the nozzle 81 (FIG. 4D).

The gate insulating film may be patterned at the same time while forming the gate pattern 12. As a result, as illustrated in FIG. 2B, a gate insulating film pattern 14 is formed between the gate pattern 12 and the active region.

Further, a heating element insulating film pattern 15 formed between the heating element pattern 13 and the device isolation film 11 may be patterned equally to the gate insulating film pattern 14 while forming the gate pattern 12 and the heating element pattern 13.

Then, first impurity ions are injected into the active region using the gate pattern 12 and the device isolation film 11 as ion injection masks to form lightly doped drain (LDD) regions 16. The first impurity ions may be n-type impurity ions or p-type impurity ions.

Referring to FIG. 2C, a spacer insulating film is formed on the entire surface of the semiconductor substrate 100. The spacer insulating film may be formed of, for example, a silicon nitride film. An anisotropic etching is performed on the spacer insulating film to form spacers 17 and 18 on sidewalls of the gate pattern 12 and the heating element pattern 13.

Second impurity ions are injected into the active region using the gate pattern 12, the spacers 17 and the device isolation film 11 as ion injection masks to form source/drain regions 19. As a result, the LDD regions 16 remain below the spacers 17 of the gate pattern 12. The second impurity ions may be n-type impurity ions or p-type impurity ions. The second impurity ions have the same conductivity type as the impurity ions injected into the active region during LDD ion injection.

Next, heat treatment is performed on the semiconductor substrate 100 having the source/drain regions 19 to activate the impurity ions in the source/drain regions 19.

The gate pattern 12, the gate insulating film pattern 14, the source/drain regions 19 and the spacers 17 form the MOS transistors 20 and 21.

The MOS transistors 20 and 21 include a switching transistor 20 and a driver transistor 21. The driver transistor 21 is a MOS type driver transistor having a withstanding voltage of about 18 to 25 V, which is used to drive a heating element 22. The switching transistor 20 is a transistor included in an integrated circuit to control the driver transistor 21 and operated by a voltage of 5 V.

A salicide process using cobalt as an example to form a metal silicide on the MOS transistors 20 and 21 and the heating element pattern 13 will be described.

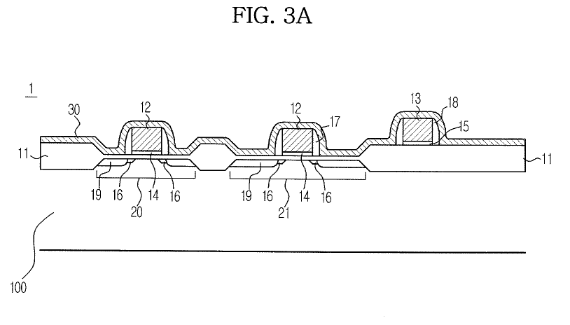

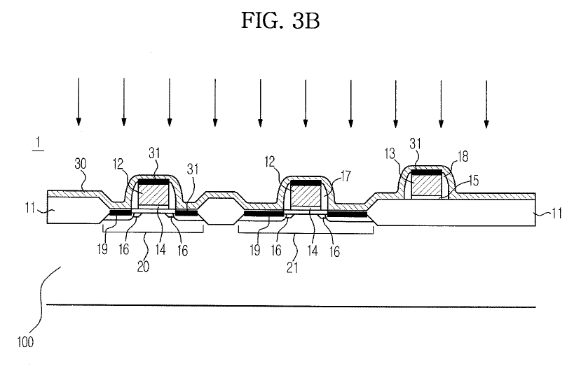

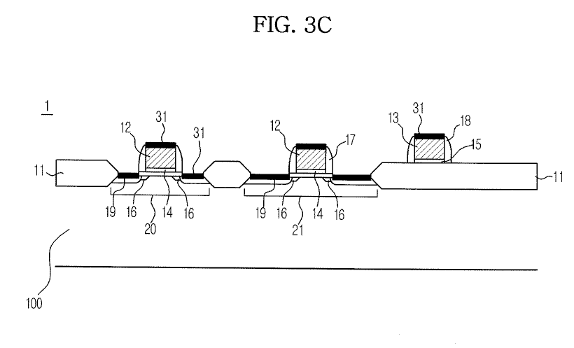

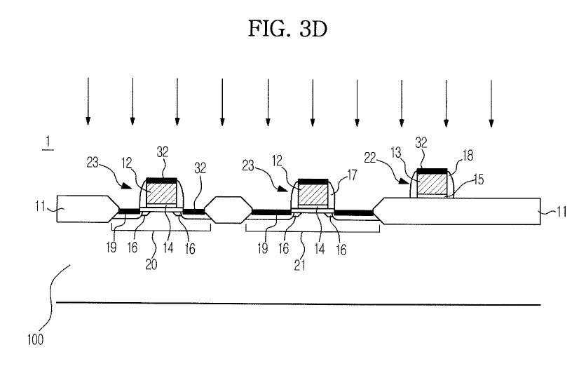

Referring to FIGS. 1 and 3A, a metal film 30 is formed on the semiconductor substrate having the MOS transistors 20 and 21 and the heating element pattern 13 (operation S2 of FIG. 1).

Referring to FIG. 3A, the surface of the semiconductor substrate 100 on which a source/drain heat treatment process has been performed is cleaned to remove a native oxide layer and contaminated particles remaining on the source/drain regions 19. The metal film 30 is formed on an entire surface of the cleaned semiconductor substrate 100. The metal film 30 may be formed of titanium or cobalt. Also, the metal film 30 may be formed of platinum, nickel, lead or the like.

Then, a first heat treatment is performed on the metal film (operation S3 of FIG. 1).

The first heat treatment may be performed through a rapid thermal sintering (RTS) process while continuously purging an atmosphere gas such as a nitrogen gas or an inert gas or through a RTS process in an ultrahigh vacuum state without an atmosphere gas.

For example, in a case of a metal film using cobalt, the first heat treatment may be performed for about 90 seconds at a temperature of about 300° C. to 600° C., such as, about 400° C. to 500° C. A temperature at which cobalt and silicon react with each other to cause a phase transition to Co₂Si or CoSi ranges from about 400° C. to 450° C. Further, a temperature causing a phase transition to CoSi₂ is greater than about 600° C. Accordingly, if the heat treatment is performed under conditions of the temperature, as illustrated in FIG. 3B, the metal film 30, the gate pattern 12 formed of polysilicon and the heating element pattern 13 react with each other to form a first metal silicide film 31 (in a case of cobalt, a Co₂Si film or a CoSi film).

Subsequently, a non-reacted metal film is removed (operation S4 of FIG. 1).

Referring to FIG. 3C, the non-reacted metal film on the spacers 17 and 18 and the device isolation film 11 is removed by performing sulfuric acid boiling. The sulfuric acid boiling can be performed for about 20 minutes by applying a mixture of sulfuric acid (H₂SO₄) and hydrogen peroxide (H₂O₂).

Then, a second heat treatment is performed on the first metal silicide film 31 (operation S5 of FIG. 1).

Referring to FIG. 3D, the second heat treatment is performed on the semiconductor substrate 100 to form a second metal silicide film 32 (in a case of cobalt, a CoSi₂ film). The second heat treatment may be performed for about 30 seconds at a temperature of about 600° C. to 900° C., such as, about 800° C. to 900° C. The first metal silicide film 31, the gate pattern 12, silicon of the source/drain regions 19 and the heating element pattern 13 react with each other by the second heat treatment to cause a phase transition to a second metal silicide film 32.

As described above, when the gate pattern 12 and the heating element pattern 13 are formed of only a polysilicon film pattern, the second metal silicide films 32 are selectively formed only on the source/drain regions 19, the gate pattern 12 and the heating element pattern 13 through a sequence of the salicide process.

Accordingly, the second metal silicide film 32 is formed on the gate pattern 12 and the heating element pattern 13, thereby completing production of the gate electrode 23 and the heating element 22.

When the metal silicide is formed through the salicide process, additional photolithography process and etching process may be omitted differently from a general silicide process. The metal silicide can be formed, for example, only on a portion of a surface where silicon components are in contact with metal.

In the salicide (self-aligned silicide) process, a metal silicide film is selectively formed on the gate electrode and the source/drain regions to reduce an electrical resistance of the gate electrode and the source/drain regions. As the electrical resistance of the gate electrode and the source/drain regions decreases, efficiency of the heating element can be improved.

Further, the gate electrode 23 and the heating element 22 are formed at a same time through the salicide process. Accordingly, an additional process to produce the heating element is omitted, thereby simplifying the process.

In this case, when there is need to make a resistance value of the heating element to be different from a resistance value of the gate electrode, that is, when the resistance value of the heating element is intended to be adjusted, the heat treatment may be independently performed on the metal film disposed on the gate pattern and the metal film disposed on the heating element pattern.

Although cobalt is employed as an example of the metal silicide film in the above description, the metal silicide film may be formed through the salicide process using titanium.

In this case, the process is almost the same as the process of forming a cobalt silicide film. However, in case of a metal film using titanium, the first heat treatment of the heat treatment process may be performed for about 30 seconds at a temperature of about 650° C. to 660° C. Thus, titanium reacts with silicon to form a first titanium silicide film (TiSi).

In each case of cobalt and titanium, sulfuric acid boiling performing time can be appropriately set. In case of titanium, sulfuric acid boiling is performed for about 20 minutes and sulfuric acid boiling is performed again for about 10 minutes to remove the non-reacted metal film.

Further, the second heat treatment is performed on the semiconductor substrate 100 to form a second titanium silicide (TiSi₂) film. The second heat treatment is performed for about 30 seconds at a temperature of about 850° C. to 870° C. The first titanium silicide film, the gate pattern 12, silicon of the source/drain regions 19 and the heating element pattern 13 react with each other by the second heat treatment to cause a phase transition to a second titanium silicide (TiSi₂) film.

Referring to FIGS. 1 and 4A, a first interlayer insulating film 40 is formed on the entire surface of the semiconductor substrate 100 having the metal silicide films 32 (operation S6 of FIG. 1). The first interlayer insulating film 40 is patterned to form contact holes 41 to expose the metal silicide films 32 formed on the source/drain regions 19 and the metal silicide film 32 formed on the heating element pattern 13. A metal film is formed on the entire surface of the semiconductor substrate 100 having the contact holes 41. The metal film is patterned to form first metal lines 42 filling in the contact holes 41 (operation S7 of FIG. 1).

The print heat 1 is connected to the MOS transistors 20 and 21 forming a driving circuit by the first metal lines 42 to form a logic integrated circuit.

Referring to FIGS. 1 and 4B, a silicon oxide film serving as an interlayer insulating film is deposited on the print heat 1 by a CVD method. Then, a spin-on silicon oxide film is coated on the print heat 1 and the silicon oxide film is planarized by an etch back method. A second interlayer insulating film 50 is formed by a silicon oxide film to insulate the first metal lines 42 and a second metal line 51 to be described later (operation S8 of FIG. 1).

In this case, although not illustrated in drawings, a hole (not illustrated) is formed on the second interlayer insulating film 50 to connect between the first metal lines 42 and the second metal lines 51.

Subsequently, the second metal line 51 is patterned on the second interlayer insulating film 50 (operation S9 of FIG. 1).

The second metal line 51 forms a power line to be connected to the first metal lines 42 of the MOS transistors 20 and 21.

The first metal lines 42 and the second metal line 51 are formed on the first interlayer insulating film 40 and the second interlayer insulating film 50, respectively. Accordingly, metal lines are arranged to be distributed into plural layers to form a width of the lines to be relatively large, thereby enabling a low resistance of the lines and improving heating efficiency.

Referring to FIGS. 1 and 4C, a surface protection film 60 is formed to protect the surface of the substrate with the second metal lines 51. The second interlayer insulating film 50 and the surface protection film 60 formed at a portion corresponding to the heating element 22 are removed through a photolithography process and a dry etching process. An anti-cavitation material layer is deposited on the remaining second interlayer insulating film 50 having a specified thickness. Then, the anti-cavitation material layer is patterned to form an anti-cavitation layer 52 (operation S10 of FIG. 1). The anti-cavitation layer 52 protects the heating element 22 from a cavitation force generated when pores inside an ink chamber 71 to be described later are contracted to become extinct. Also, the anti-cavitation layer 52 prevents the heating element 22 from being corroded due to ink. The anti-cavitation layer 52 is formed of tantalum (Ta) at the portion corresponding to the heating element 22 to have a specified thickness.

Then, as illustrated in FIG. 4D, a channel forming layer 70 is arranged in the print head 1 by pressing (operation S11 of FIG. 1). After a portion corresponding to the ink chamber 71 and an ink channel is removed, the channel forming layer 70 is hardened to form a partition wall of the ink chamber 71, a partition wall of the ink channel and the like. Then, a nozzle layer 80 with a nozzle 81 is stacked at a portion corresponding to each heating element 22 (operation S12 of FIG. 1).

In this case, the nozzle layer 80 is a plate-shaped member formed in a specified shape to form the nozzle 81 above the heating element 22 and supported on the channel forming layer 70 by adhesion. Accordingly, the print head 1 is formed by forming the nozzle 81, the ink chamber 71, the ink channel to introduce ink to the ink chamber 71 and the like. The print head 1 is formed such that plural ink chambers 71 are continuously arranged, thereby forming a line head.

The inkjet print head having the above configuration according to an embodiment of the present general inventive concept, a sequence of a manufacturing method thereof, and an operation thereof will be described.

In the above configuration, in the print head 1, a silicon substrate 100 serving as a semiconductor substrate is sectionalized by device isolation films 11 to form transistors 20 and 21 serving as a metal oxide field effect transistor and a heating element, which are insulated by a first interlayer insulating film 40 to form first metal lines 42. The transistor 21 to drive the heating element 22 is connected to the transistor 20 to form a logic circuit by the first metal lines 42. Further, subsequently, a second interlayer insulating film 50 and a second metal line 51 are formed and the heating element 22 is connected to the driving transistor 21 by the second metal line 51. Also, lines of a power source line, a ground line and the like are formed.

Further, an anti-cavitation layer 52, a channel forming layer 70 defining an ink chamber 71, a nozzle layer 80 with a nozzle 81 are sequentially stacked in the print head 1.

Accordingly, in the print head 1, the ink is introduced into the ink chamber 71 through an ink channel and the ink accommodated in the ink chamber 71 is heated by driving the heating element 22 to generate pores. When the pressure in the ink chamber 71 rapidly increases by the generated pores, the ink in the ink chamber 71 is ejected from the nozzle 81 and ink droplets are attached to a paper or the like.

In the inkjet print head 1 according to an embodiment of the present general inventive concept, the heating element 22 can be formed simultaneously in the same manner as when a gate electrode 23 of the transistors 20 and 21 is formed on the substrate 100. Accordingly, an additional process to provide the heating element is omitted, thereby promoting efficiency of a manufacturing process.

Further, the gate electrode of the transistors 20 and 21 to drive the heating element 22 is formed of a cobalt silicide film, a titanium silicide film or the like through a salicide process. Accordingly, compared to a conventional gate electrode formed of polysilicon or the like, a resistance in driving the transistors is reduced and, thus, the heating element 22 can be efficiently driven.

The first metal lines 42 and the second metal line 51 are formed on the first interlayer insulating film 40 and the second interlayer insulating film 50, respectively. Accordingly, metal lines are arranged to be distributed into plural layers to form the width of the lines to be relatively large, thereby enabling a low resistance of the lines and improving heating efficiency.

As described above, in the inkjet print head and the manufacturing method thereof according to an embodiment of the present general inventive concept, the heating element 22 can be formed simultaneously in the same manner as when a gate electrode 23 of the transistors 20 and 21 is formed on the substrate 100. Accordingly, an additional process to provide the heating element is omitted, thereby promoting efficiency of a manufacturing process.

Further, according to various embodiments of the present general inventive concept, a metal silicide film is formed on the gate pattern and the heating element pattern through the salicide process. Accordingly, additional photolithography process and etching process can be omitted, thereby simplifying the process.

Further, according to various embodiments of the present general inventive concept, the gate electrode of the transistors to drive the heating element is formed of a metal silicide film through a salicide process. Accordingly, compared to a conventional gate electrode formed of polysilicon or the like, a resistance in driving the transistors can be reduced and, thus, the heating element can be efficiently driven.

Further, according to various embodiments of the present general inventive concept, the first metal lines and the second metal line are formed on the first interlayer insulating film and the second interlayer insulating film, respectively. Accordingly, metal lines are arranged to be distributed into plural layers to form the width of the lines to be relatively large, thereby enabling a low resistance of the lines and improving heating efficiency.

Although various embodiments of the present general inventive concept have been illustrated and described, it would be appreciated by those skilled in the art that changes may be made in these embodiments without departing from the principles and spirit of the general inventive concept, the scope of which is defined in the appended claims and their equivalents.

What is claimed is:

1. An inkjet print head, comprising:
a substrate;
a heating element stacked on the substrate to heat ink;
a transistor having a gate electrode to drive the heating element;
a chamber layer to form an ink chamber filled with the ink above the heating element; and
a nozzle layer stacked on the chamber layer to form a nozzle to eject the ink,
wherein the gate electrode and the heating element include a metal silicide film formed through a salicide process.

2. The inkjet print head according to claim 1, wherein the metal silicide film comprises:
a titanium silicide film or a cobalt silicide film.

3. The inkjet print head according to claim 1, wherein first and second interlayer insulating films are formed between the heating element and the chamber layer, and first and second metal lines are patterned on the first and second interlayer insulating films.

4. An inkjet print head, comprising:
a plurality of chambers filled with ink, a plurality of heating elements to heat the ink in the chambers, a transistor to apply current to the heating elements, and a plurality of nozzles corresponding to the chambers,
wherein the heating elements include a heating pattern formed of polysilicon and a metal silicide film formed by performing heat treatment on a metal film stacked on the heating pattern.

5. A method of manufacturing an inkjet print head, the method comprising:
forming a gate pattern and a heating element pattern on a substrate;
forming a metal film on the substrate;
performing a first heat treatment on the metal film such that the gate pattern and the heating element pattern react with each other to form a first metal silicide film;
removing a non-reacted film remaining on the substrate;
stacking an interlayer insulating film on the substrate to form a metal line;
stacking a channel forming layer to provide an ink chamber at a portion corresponding to the heating element pattern; and
stacking a nozzle layer such that a nozzle is formed at a portion corresponding to the ink chamber.

6. The method according to claim 5, further comprising:
performing a second heat treatment after removing the non-reacted film to form a second metal silicide film.

7. The method according to claim 5, wherein the stacking an interlayer insulating film on the substrate to form a metal line comprises:
stacking a first interlayer insulating film on the gate pattern and the heating element pattern with the metal silicide film to pattern a first metal line; and
stacking a second interlayer insulating film on the first metal line to pattern a second metal line.

8. The method according to claim 5, wherein the metal film is formed of cobalt.

9. The method according to claim 5, wherein the metal film is formed of titanium, and the first heat treatment is performed at a temperature of to 650˜670° C.

10. The method according to claim 6, wherein the metal film is formed of titanium, and the second heat treatment is performed at a temperature of to 850˜870° C.

11. The method according to claim 6, wherein the second metal silicide film comprises:
a TiSi2 film or a CoSi2 film.

12. The inkjet print head according to claim 1, comprising:
a plurality of interlayer insulating films; and
a first set of metal lines and a second metal line formed on the plurality of interlayer insulating films, respectively,
wherein the metal lines are arranged in plural layers to form a width.

13. The method according to claim 5, further comprising:
simultaneously forming a heating element and a gate electrode.

14. The method according to claim 5, comprising:
forming a plurality of interlayer insulating films; and
forming a first set of metal lines and a second metal line formed on the plurality of interlayer insulating films, respectively, such that the metal lines are arranged in plural layers to form a width.
